(19) United States
(12) Patent Application Publication
(10) Pub. No.: US 2018/0154581 A1
(43) Pub. Date: Jun. 7, 2018

(54) MATERIAL AND METHOD FOR 3-D FABRICATION

(71) Applicant: Wildcat DP LLC, Berkeley, CA (US)

(72) Inventor: Paul M. DENTINGER, Sunol, CA (US)

(73) Assignee: Wildcat DP LLC, Berkeley, CA (US)

(21) Appl. No.: 15/848,352

(22) Filed: Dec. 20, 2017

Related U.S. Application Data
(63) Continuation of application No. PCT/US2016/044908, filed on Jul. 29, 2016.
(60) Provisional application No. 62/199,116, filed on Jul. 30, 2015.

(51) Int. Cl. B29C 64/40; B29C 64/106

(52) U.S. Cl. CPC B29C 64/40; C08L 55/02; B29C 64/106

(57) ABSTRACT

3-D printing techniques including adhesion of acrylonitrile-butadiene-styrene deposited onto PVA sacrificial material (or vice versa) via the use of block co-polymers are disclosed. The addition of block polymers to PVA can be used for the adhesion of other FDM materials with PVA support materials. Other techniques include star, comb, ter-, tetrapolymers and the like; copolymers for adhesion of FDM materials to PVA or other support materials. The technique of block copolymer addition to PVA can also enhance the usefulness of PVA as a FDM material itself, either by enhancing its adhesion to support material, or by providing appropriate surface characteristics to the final part. The technique can also be used to enhance the adhesion of other support materials to the FDM part of interest. The technique can be used to allow for PVA to be used as the FDM material, while using a different support material, if any.

### CROSS-REFERENCE TO RELATED APPLICATION

This application is a continuation of International Application No. PCT/US2016/044908, filed Jul. 29, 2016, which claims the benefit of priority to U.S. Provisional Application No. 62/199,116, filed Jul. 30, 2015, both of which are incorporated by reference herein in their entireties.

### BACKGROUND

### 1. Technical Field

The present disclosure relates to materials for 3-D printing, and in particular for adhesion of sacrificial materials to design materials using block copolymers during additive manufacturing.

### 2. Description of Related Art

Additive manufacturing has received renewed interest in the past decade. While techniques such as stereolithography have enjoyed some success as early as the 1980's, the advent of additional additive techniques has been rapidly gaining interest in the past decade. At least two major reasons for this are that 3-D CAD software has become available to a much larger population, and the robotic movement of light or mechanical “printhead” assemblies is far more commoditized today. As such, techniques such as selective laser sintering (SLS) have become standard to make parts for some time, and fused deposition modelling (FDM) where the print head must traverse the entire part and extrude material, is inexpensive enough to open new markets.

In many techniques where spatially modulating light is used to build up a part, the part is made from either liquids that are polymerized or solids that are melted at the focal point of the light. In those cases, build-up of “overhang” features is sometimes possible as the part is derived from a bulk material of similar density. For example, in stereolithography, a stage may be submersed in liquid monomers. The top of the stage may be submersed approximately the focal depth of the impinging light, and the base of the part exposed and polymerized onto the stage. A subsequent step of lowering the stage further into the polymerization mixture is performed, followed by a subsequent exposure of the next layer. In this way, the footprint of the second layer can be larger than the footprint of the first layer provided they are connected. Subsequent lowering of the stage and light exposure provides the part of interest.

In addition to stereolithography where the part is traditionally made by lowering the stage, schemes exist where the part is exposed from below and the stage is raised. Other schemes may also exist. One limitation of light polymerized 3-D printing is that materials must be made that match the light activation processing of the technique. Photopolymerizable materials are considerably more expensive than their thermoplastic counterparts and importantly do not often take advantage of over 75 years of thermoplastic materials development that exists for commodity resins such as nylon, acrylonitrile-butadiene-styrene (ABS), high impact polystyrene (HIPS), polycarbonate (PC), vast types of polyolefins (PE, PP, UHMW, etc.), poly lactic acid (PLA) and even more recent extremely high performance resins such as fluoropolymers, PEEK, self-reinforced polymers (SRP), poly phenylene sulfide (PPS), some silicones, and a host of highly-engineered, filled resins and composites.

Some of the materials not accessible to the stereolithography market can be addressed in the selective laser sintering (SLS) technique. In this technique, pure materials including some engineering thermoplastics are present in solid form such as small spheres. An image from a high power light source is focused such that the absorption of the polymer in a small area melts the material and fuses the solid particles. By stepping the particles and the illumination foci, parts can be built from existing solidus thermoplastic resins and even metals and ceramics. Hence SLS may have a broader range of existing materials available to it than stereolithography. But SLS also limits the materials choices to those amenable to high photon density absorption, melting, and fusing without significant degradation of materials properties resulting from the processing.

In another technique of additive manufacturing, one could extrude a material through a thin nozzle or “printhead” and move the printhead through a path in space depositing thermoplastic resins along the way. A major advantage of FDM is the accessibility to engineered thermoplastic resins and even reaction-injection materials. Greater than seventy-five years of injection molding, hot embossing, and various extrusion techniques have evolved an extremely diverse set of materials from highly specialized and high performance materials to the least expensive materials on the planet. With the only real constraint that the material be melted to a processable viscosity and cooled to return to its properties, the existing materials infrastructure is readily accessed.

Unlike injection molding, however, 3-D printing via FDM does not by its nature have features to confine the melted polymer prior to cooling. As such, materials that have similar processing characteristics need to be deposited in areas where the part requires stabilization, such as “overhang” structures. In this case, a second material is deposited. This second material must be selectively removed from the primary part material(s) after the printing process has finished. Hence, the material used to mechanically stabilize the desired part material is referred to as support material or sacrificial material, in the sense that its primary purpose is processing aid and is sacrificed in lieu of the finished part.

The sacrificial material must meet certain criterion. First, it must be inexpensive in the sense that the material is processed and used, but not utilized for the intended purpose of the final part. The second is that it should have similar processing characteristics as the primary material in the sense that the primary material(s) will have certain printhead requirements, storage requirements, etc., and if the sacrificial material requires additional or completely different handling characteristics, tool complexity will result. The third is that the sacrificial material must be suitable for the stabilization of the part of interest. In a practical sense this not only requires some level of dimensional stability in the sense of water absorption, coefficient of thermal expansion and the like, but also have acceptable adhesion to the part of interest so the part of interest does not separate, “pull-out”, pull-back”, etc. during manufacture and lose part tolerance or cause the printhead to collide in subsequent layers. Lastly, the sacrificial material must have good capability to separate cleanly from the desired part after printing preserving overall cost, cycle time, and mechanical characteristics of the part of interest. Traditionally, a material that has a requirement for good adhesion during manufacture, but then needs to cleanly separate after manufacture can use differential solubility during separation.

One such material that meets many of the requirements of an ideal sacrificial material is polyvinyl alcohol, PVA or PVOH. PVA is an inexpensive, partially crystalline thermoplastic material that is water soluble and biodegradable. Since many thermoplastics of interest as final parts are not water soluble, PVA has the major strategic advantage of ease of processing after the part is made by immersing in water. Being biodegradeable and in use in many consumer/cosmetic formulations, dishwashing applications and the like, the material has a well established and accepted environmental footprint which translates to green manufacturing and overall lower cost of operations. One major issue with PVA, however, is that because its melt temperature is so close to its decomposition temperature, the material has a tendency to pyrolise and loses its water solubility when extruded at appropriate temperatures. The lack of material characteristic retention after extrusion has been the subject of many patents, and commercially available materials that claim success with extrudable PVA exist such as the trade-named Nichigo G-polymer from Nippon Goshei, Mowiflex from Kuraray, and Elvanol from DuPont.

There are two predominant methods presently employed to prepare melt-processable PVA. The first is plasticizers and the second is copolymerization. Plasticizer addition were first reported in the patent literature in the 1980s and 1990s. Typically a polymer or smaller molecule with acceptable thermal characteristics is coprocessed with the PVA in, for, example a screw extruder. The second material interferes with the hydrogen bonding network of the PVA to lower the melt temperature. There are many potential plasticizers available that may also maintain water solubility, biodegradability and cost, and this appears to be the choice of the presently available extrudable PVA's. The second technique would be to copolymerize the PVA precursor (vinyl acetate) with a second monomer that disrupts the hydrogen bonding network of the PVA. One challenge of this technique is incorporating enough co-reactant into the polymer to affect significant melting point range, but not affecting biodegradability, water solubility and cost. Lastly, since PVA is made by polymerizing polyvinyl acetate (PVAc) and then hydrolyzing to the alcohol, some formulation result in a copolymer of vinyl alcohol and vinyl acetate simply by controlled lack of hydrolysis.

Melt-processable PVA then solves one issue with the use of PVA as a sacrificial material. However, PVA is chemically unlike many of the engineering thermoplastic resins. While this suffices for differential solubility between the desired part and the sacrificial material, this makes for poor adhesion between the two materials during part manufacture. A good example of this trade-off between compatibility of the sacrificial material but the need for differential solubility is the ABS system. When an ABS part is made, the sacrificial material is polystyrene (PS), or more preferred high impact polystyrene (HIPS) which typically includes butadiene elements. The ABS can sufficiently wet and adhere to HIPS, but the resulting part must be processed in a material that selectively dissolves HIPS from ABS, with the predominant material in use being d-limonene. In this process, then, a significant waste stream of solvent and HIPS is created, plus further cleaning of the ABS part to rid it of solvent prior to finish is encountered. Hence, it is desirable to produce a PVA formulation that is both melt extrudable, but also can be configured such that ABS could adhere to it during processing, but also is water soluble and biodegradable after printing. This is true for all other final part materials of interest listed above.

Polymers are molecules made from long chains of smaller, repeating units. Typically, polymers can be as short as 3 “mers” to as long as hundreds of thousands of “mers”. One distinguishing characteristic of polymers is the configurational entropy of the long chains in the bulk or melt phase. This configurational entropy tends to be maximized when the chain is present amongst itself vs. other chains. Hence, while solubility of solvents with each other typically follow the rule of “like solubilizes like”, polymers are a bit of an extreme example of this rule: they have additional incentive to not mix, and tend to not mix without significant compatibility of the -mers. It follows then, that highly water soluble and biodegradable PVA, is unlikely to have chain mixing with the extruded thermoplastics of the 3-D printed part. As such, good mechanical adhesion is unlikely.

In addition to interlocking chains, however, good wetting can be sufficient for adhesion. Without chain entanglement, it is still rational for one polymer to wet onto another during the melt phase, and the adhesion in this case would be purely Van Der Waals forces. While these are not structural bonds, per se, they may be sufficient for part manufacture. However, good wetting also requires some affinity for the two materials, even if it is not sufficient to overcome the self-interest of configurational entropy. The main criterion in this case is a subtle interplay between the surface energy of the sacrificial material and the depositing medium (likely air), the surface energy of the extruded material and the depositing medium and the interfacial energy between the two materials. With favorable thermodynamics and enough energy for the extruded material to kinetically obtain the appropriate shape, the deposited material can wet the sacrificial material. However, with the wrong thermodynamics, the deposited material will “ball up” or dewet from the sacrificial material, forming virtually no bond. Van Der Waals forces are indeed weak on a per bond basis, but with intimate contact coming from good wetting and melt processing, the number of bonds per area might be sufficient for part manufacture; typically stresses from cooling the thermoplastic on the sacrificial material. Good wetting plus some entanglement will produce even better mechanical adhesion, but without either, poor adhesion and likely low or negligible process latitude for good part manufacture will result.

One way to promote wetting and entanglement is through the use of additives (molecules, polymers, etc.) to the bulk polymer. The additive may be intermediate affinity, or affinity for each of the materials. Such an additive will orient itself in the PVA polymer to minimize energy of the system; if the additive is added to a low surface energy polymer, typically by forming micelles or other such secondary structure. If the additive is added to the higher energy polymer, then will migrate to the surface with the low surface energy end unusually dominant at the surface to lower the overall surface energy of the solid. Upon further addition, micelles or other secondary structure result.

Polyvinyl alcohol is made from relatively high energy -mers by organic materials perspective. As such, surfactants or block copolymers of vinyl alcohol and traditional carbonaceous polymer materials such as styrenics, olefins, acrylics, nylons, polyesters, glycolic acids and esters, lactic acids and esters, cellulose and its derivatives, chlorostyrenes, epoxies, acrylonitrile, propylene or ethylene oxides co- and ter-polymers of these and the like would result, for example, in the styrenic moiety predominantly segregated to the surface while the polyvinyl alcohol tail would predominantly mix with the bulkPVA material. Excess addition of a styrenic vinyl alcohol block copolymer, for example, would result in secondary structures such as micelles, rods, etc. A similar argument can be made for nearly all polymeric materials as copolymers of PVA such as olefins, acrylics, lactic acid, silicones, fluoropolymers, styrenic-olefinic segments such as found in HIPS and ABS, acrylolnitrile, and the like as the vinyl alcohol has a high surface energy due to its high hydrogen bonding fraction. In addition, there is some value in adding the adhesion promoting additive to the PVA when it is sacrificial, as reformulating the highly engineered thermoplastics such as ABS is not as desirable in the sense that existing, commoditized versions with long design history from many manufacturers may be used as is, instead of reformulation being required.

Previous teachings focus on allowing the PVA to be extrudable for additive manufacturing techniques, mostly by the addition of plasticizers and the like. This disclosure focuses on improving the adhesion between PVA and the desired part.

Copolymers of two different -mers may be random, atactic, syndiotactic, or “blocky”, depending on synthesis. A completely random copolymer of vinyl alcohol and a low surface energy component may not mix with PVA and therefore may be unpreferred. However, it may be true that a pure block copolymer may not be necessary as well, simply having “blocky” sections within the polymer may be sufficient for surface segregation and improved adhesion or wetting between the part and PVA. In addition, diblock copolymers are not the only method of providing surface segregation of incompatible moieties to the surface of the sacrificial material; triblock, comb, graft, and star polymers, and dendritic materials and others may be preferred either for performance or for the cost of polymerization.

Traditional water soluble support material, such as polyvinyl alcohol, generally has acceptable extrusion characteristics, water solubility and is biodegradable, but adherence strength to part material is relatively low and may cause difficulties during part manufacture. As such, parts from highly engineered materials such as acrylonitrile-butadiene-styrene (ABS) currently use solvent-soluble support materials rather than PVA.

3-D printing is an additive method of manufacture of great interest as the part is directly fabricated from condensed material to arbitrary shapes. Material is converted either from bulk thermoplastic extruded through a nozzle moving in all axis (fused deposition modelling, FDM), or from spatially modulating light intensity for either melt fusing material, chemically polymerizing, or the like. Additive manufacturing, especially FDM, often requires support (or sacrificial) material to assist in the build-up of the part. The support material should allow for adhering to the part and therefore the part material during manufacture. The support material should also be easily removed after part manufacture.

### SUMMARY OF THE INVENTION

A water-soluble support (i.e., sacrificial) material for the build-up of 3-D parts is disclosed. Additive materials can be added to a base material, such as a base sacrificial polymer (e.g., PVA), to create support materials that have acceptable adhesion for many FDM part materials (e.g., ABS) while maintaining water solubility and favorable environmental footprint of the support materials. Furthermore, the additive materials can be added to PVA such that the resulting material can be used as the final part material.

The present disclosure addresses the issue of compatibility between PVA and other polymers of additive manufacture by using polymer or material additives with different characteristics in different segments of the molecule of the additive material, such as surfactants or blocky copolymers. An additive material surfactant and/or block copolymer can be added to the bulk polymer PVA, for example from about 0.05% to about 3% or more narrowly from about 0.1% to about 1.5% by weight. The added surfactant and/or block copolymer can have a PVA block or end (or other suitable PVA-philic block or end such as some sugars or alcohols), and a block or end compatible with the material to be formed into the part of interest.

The additive materials can be di-block copolymers of the “AB” type as one bock can be soluble in PVA and the other block for wetting or chain intermixing for the intended part material. Free radical polymerization of one moiety temporally followed by free radical of the second moiety can produce a “blocky” ABA triblock copolymer. Copolymers can be added to PVA while retaining the sacrificial material properties compared to the pure PVA and increase the surface adhesion of the sacrificial material (now comprising the additive material and PVA compared to the pure PVA) to the thermoplastic part material during three-dimensional printing.

Furthermore, in the production of PVA as the final part in the case where the final part desired is PVA, surface segregated species in the PVA allow for PVA adhesion to the sacrificial support material in that case, as would be expected from those familiar with the state of the art.

Materials and methods are disclosed that allows ABS parts to process with and adhere to PVA-based sacrificial materials during additive manufacture. The additive material can have a blocky styrenic-PVA copolymer or other such blocky material as described herein. The additive material can be added to the high surface energy polymer, PVA. The styrenic moieties will preferentially segregate to the surface of the sacrificial material, where subsequent part material (e.g., ABS) extrusions can wet or slightly entangle, allowing the part material (e.g., ABS) to stick to the sacrificial material (e.g., PVA and the additive material). The additive material can have isobutylenic species instead of, or in conjuction with, styrenic species in the non-PVA blocky part, or other such olefinic, acrylic or other species as described herein The additive material can have polystyrene-PVA diblock, and/or poly 4-methyl or alpha-methyl styrene blocks, for example for use with a part material having ABS. The additive material can have other styrenes such as alkyl styrenes, as well as triblock polymers, star polymers, comb polymers, dendritic polymers, or combinations thereof, or PVA-block copolymers with other species of the ABS system such as acrylonitrile or isobutylene. The additive material can also have a low energy block having random components such as styrene and n-butyl (meth)acrylate in one block and PVA in the other block, or styrene graft olefinic species in one block. The blocks can be made from a variety of -mers as described herein.

### BRIEF DESCRIPTION OF THE DRAWINGS

FIG. 1 illustrates extruded spools of sacrificial materials. The left-most spool is of pure PVA. The middle two spools have increasing ratios of additive material. The right-most spool is PVA with a lower ratio of additive material than in the middle two spools.

FIG. 2 illustrates a variation of the part material deposited on the sacrificial material,for example to assess the adhesion between the part material and the sacrificial material.

FIGS. 3 is a graph showing the number of layers of part material before the part material separates passively from the sacrificial material during adhesion testing, for example, for the test structure shown in FIG. 2.

FIG. 4a illustrates a method of manufacturing a part with the part having sacrificial material and part material.

FIG. 4b illustrates the part of FIG. 4a after the sacrificial material has been removed from the part.

### DETAILED DESCRIPTION

Sacrificial or support materials can be used during three-dimensional printing in contact with component or part materials. The sacrificial materials can include one or more additive materials (i.e., adhesion enhancers) mixed with PVA/PVOH, and optionally with a marking material. The additive materials can be blocky polymers used either in combination or alone. The additive materials can increase adhesion of the sacrificial material (compared to the sacrificial material without the additive materials) to the part material (e.g., ABS) during the three-dimensional printing, such as during FDM. The sacrificial material can be water soluble. Water can be applied (e.g., by spraying, rinse, soaking, immersion, or combinations thereof) to the entire part and/or just the sacrificial material to remove the sacrificial material during or after application of the sacrificial material to the part material. After the water has been applied and removed, the part can be inspected, for example to check for specific marking materials (e.g., by application and detection of visual light, fluorescing energy, ultrasound energy, radiation energy, or combinations thereof) to confirm removal of all, or at least a desired portion of the sacrificial material from the part material.

The additive material (i.e., adhesion enhancer) can be a block polymer of star, graft, dendritic, ter-, tetra- or co-polymer, or combinations thereof. The additive material can be PVA-b-PS, PVA-b-PVT (also known as 4-methylstyrene), PVA-b-olefinic styrene such as ethyl-propyl, butyl, etc. styrene, PVA-b-alpha methyl styrene, PVA-b-styrene n-butyl (methacrylate), PVA-b-styrene graft olefinic, PVA in block with epoxies, lactic acids or esters, glycolic acids or esters, olefins, silicones, epoxies, acrylates and methacrylates, cellulose derivatives, halostyrenes, ethylene or propylene oxides, olefinic amides and esters, aromatic amides and esters, acrylonitrile, or combinations thereof. One block of the additive material can have a substantially similar or identical solubility parameter to the remainder of the sacrificial material (e.g., PVA), and another block of the additive material can have a substantially similar or identical solubility parameter to the part material (e.g., ABS). One block of the additive material can be styrenic (e.g., alkyl styrenes, poly 4-methyl or alpha-methyl styrene) and/or isobutylenic or others as described herein. One block of the additive material can be PVA. One block copolymer of the additive material can be in hydroxypropyl methyl cellulose.

The block co-polymer can have a first block segment with a solubility parameter from about 75% to about 125%, more narrowly from about 90% to about 110%, for example about 100%, of the solubility parameter of the sacrificial material (e.g., PVA). The block co-polymer can have at least one second block segment with a solubility parameter from about 75% to about 125%, more narrowly from about 90% to about 110%, for example about 100%, of the solubility parameter of the part material (e.g., ABS).

The block co-polymer can have a first block segment having wettability or solubility toward the sacrificial material (e.g., PVA). The co-polymer can have at least one second block segment having wettability and/or solubility toward the part material (e.g., ABS).

The part material can be or have ABS, aliphatic or semi-aromatic polyamide (e.g., nylon or a nylon composite), carbon fiber composite, amorphous thermoplastic polyetherimide (e.g., ULTEM from Saudi Basic Industries Corporation (SABIC) of Riyadh, Saudi Arabia), or combinations thereof.

The sacrificial material can have PVA with additive (PS-b-PVA). The vinyl alcohol polymer can be synthesized as polyvinyl acetate and hydrolyzed to PVOH. Reversible addition-fragmentation chain transfer (RAFT) agents can be used in the synthesis. The synthesis can be verified using gel permeation chromatography (GPC) and proton nmr.

The designed molecular weights were PS component of Mn=1000-1600 and PS-b-PVac of approximately Mn=4200-5200. Actual molecular weights were PS Mn=1300 (˜14 repeat units) and PS-b-PVAc total Mn=4100 (approximately 44 repeat units of vinyl alcohol after hydrolysis). Roughly equivalent molecular weights of the two blocks may be more desirable for compatibilizing the ABS with PVA, but perhaps at the expense of solubility in the PVA or eventual water solubility of the additive. Polystyrene or styrenic components may be in the range of 1-100,000 repeat units long, and PVOH segments can have a similar range.

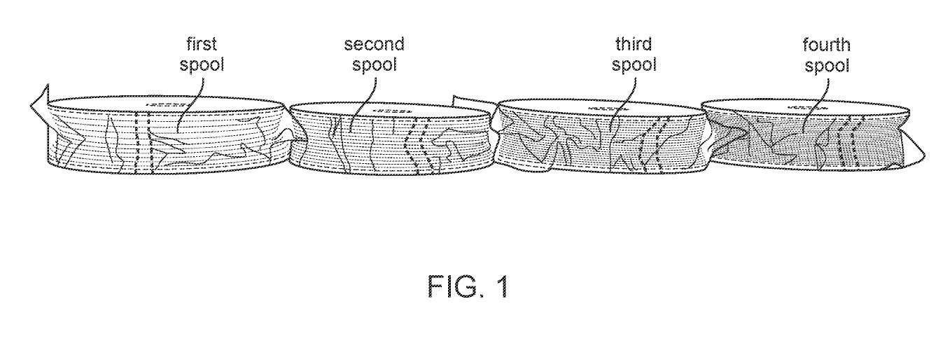

The resulting block copolymer can be added to extrudable PVOH. The sacrificial material can be formed into filament or threads and placed on spools for use in three-dimensional printing, as shown in FIG. 1. The sacrificial material can range from about 0.01% to about 5% of the additive material, more narrowly from about 0.25% to about 1% of the additive material, for example about 0.75% of the additive material. The remainder of the sacrificial material can be, for example, PVOH, optionally with one or more substantively inert marking materials, such less than 1%, more narrowly less than about 0.2% of a coloring, fluorescing, echogenic, or radiopaque agent, or combinations thereof. The sacrificial material can be water soluble in all formulations.

### EXAMPLE 1

A polystyrene-b-polyvinyl alcohol (PS-b-PVA) copolymer was synthesized using RAFT polymerization techniques to a Mn of 1300 (PS component) and Mn of PS-b-PVac=4100 prior to hydrolysis to PVA. Extrudable PVA was extruded into 1.75 mm filament (e.g., from UltiMachine of South Pittsburg, Tenn.) and chopped to approximately 3 mm long pieces. 4 g of the chopped PVA was and transferred to an aluminum barrel at 185 C and let sit for 15 min. for melting. The material melted and a drill was inserted rotating counterclockwise to extrude the material through a 1 mm orifice. A polystyrene substrate was placed and moved under the extrudate to form a film of PVA on PS. In a second experiment with a second A1 barrel, 0.03 g of PS-b-PVA block copolymer was weighed and brought up to 4 g with the chopped PVA so that the final composition was approximately 0.75% with PS-b-PVA block copolymer. Both were transferred to an A1 barrel and brought to 185 C in the barrel and 15 min. was elapsed to assure good mixing. And again a counter-rotating drill was used to extrude strips from a 1 mm orifice onto a polystyrene substrate. To further the experiment, ABS was extruded from a 3-doodler onto strips of the PVA on PS. Better wetting of ABS to PVA was observed on the PVA with block copolymer. Peeling of the ABS from the PVA with block copolymer also revealed better adhesion than the ABS on pure extrudable PVA.

### EXAMPLE 2

PVA-block-polyvinyltoluene (PVT) can be synthesized using similar RAFT techniques to a number average molecular weight of 1800 for PVA and 1700 for PVT. Both the PVA-b-PS and the PVA-b-PVT were mixed at 0.75 wt. % with PVA (e.g., MOWIFLEX from Kuraray Co., Ltd of Tokyo, Japan) and extruded to 1.75 mm filament.

FIG. 1 illustrates spools from an extrusion run of PVA-b-PS. PVA-b-PS can be slightly yellow. The spool on the left of FIG. 1 is the pure PVA. The 3^{rd} spool from the left in FIG. 1 illustrates the PVA-b-PS compounded and hence more yellow than the pure PVA. A similar result was obtained for the PVA-b-PVT additive, though it was less colored than the PVA-b-PS.

The pure PVA, PVA with PVA-b-PS, and PVA with PVA-b-PVT can be extrusion tested for adhesion. The filament with additive can have more adhesion to ABS than the filament of pure PVA.

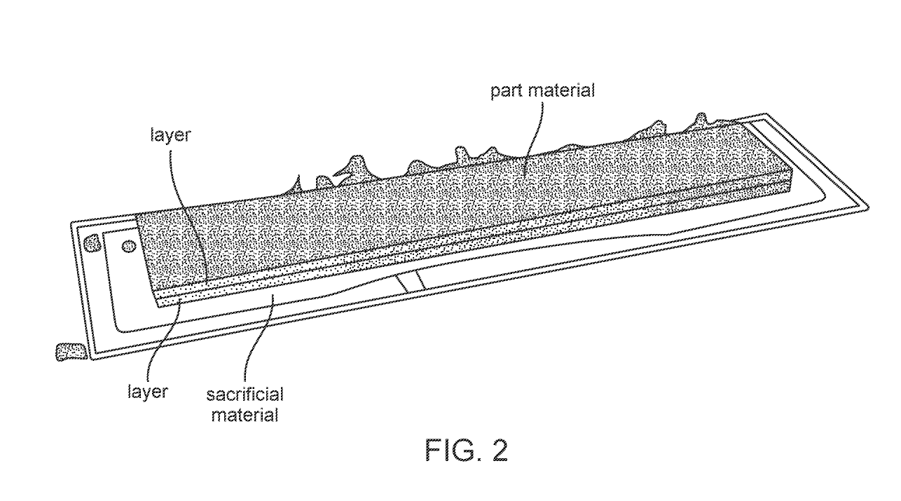

FIG. 2 illustrates a variation of the adhesion test. Successive layers of a part material (e.g., ABS) were deposited on top of a long and skinny section (0.75 in.×4 in.) of sacrificial material (e.g., HIPS or PVA with or without additive material) two layers thick. Up to 15 layers of the part material were applied to the sacrificial material. The layers of part material (i.e., ABS in the testing) built up more stress between the part material and the sacrificial material (e.g., ABS and HIPS or PVA with or without additive material) interface. The layer count before adhesive failure of the joint—shown by delaminating—can be judged as a strength of the adhesion between PVA and ABS vs. PVA with additive and ABS.

ABS and HIPS adhered in the test such that more than 12 layers of ABS were applied to the ABS without the HIPS separating from the ABS.

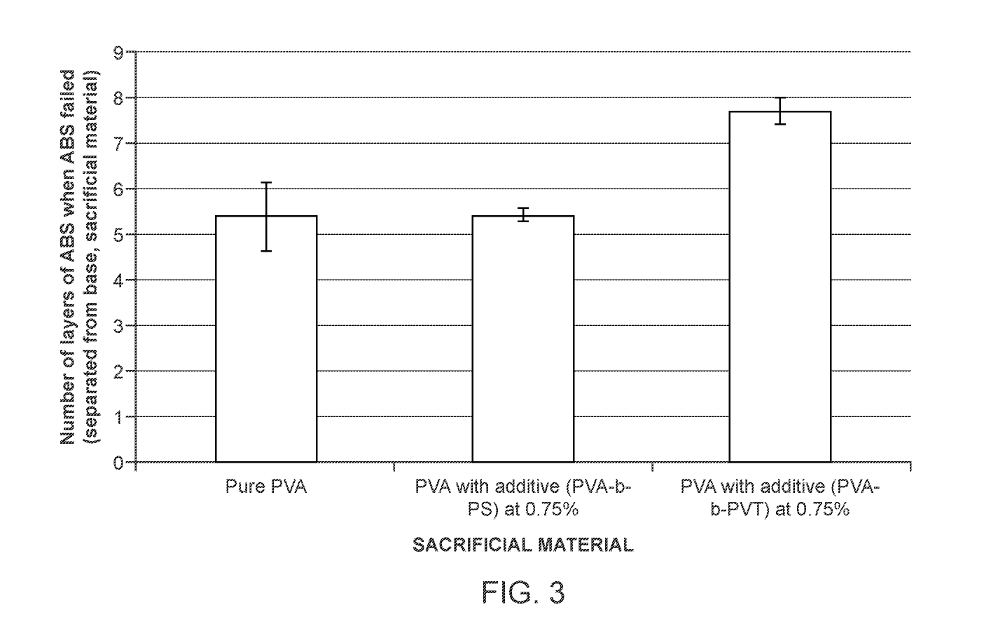

FIG. 3 illustrates the number of layers at which the ABS part material can be deposited before separation from the PVA and PVA with additive sacrificial (i.e., underlayer) material during the adhesion testing. The adhesion failure occurs at the interface between the sacrificial and part material at the edge of the part. The sacrificial material having PVA with the PVA-b-PVT block copolymer adheres more strongly (failing on average at layer 7.5) than the raw PVA and PVA with the PVA-b-PS block copolymer additive (failing around layer 5). The surface of the PVA with PVA-b-PS can be benzyl rich, and the ABS can adhere only moderately well to pure polystyrene.

### EXAMPLE 3

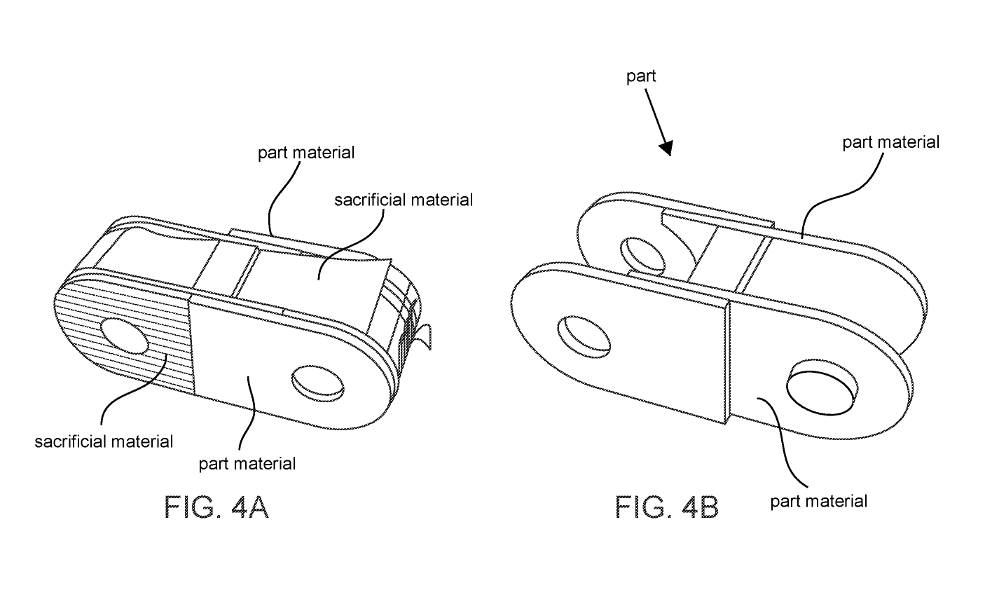

FIG. 4a illustrates that the sacrificial material having PVA with additive can be used to manufacture a part. The part material can be or have ABS. The sacrificial material (e.g., Wildcat DP from Wildcat DP LLC of Sunol, Calif.) can be or have PVA with additive sacrificial material as described above. The part material can have a different color (e.g., the part material can be black and the sacrificial material can be off-white), fluorescence, echogenicity, radiopaqueness, or combinations thereof than the sacrificial material.

FIG. 4b illustrates the part (e.g., an energy chain link) remains after the part and sacrificial material of FIG. 4a have been immersed in water. The water can dissolve and remove the sacrificial material. The water can be applied by itself (e.g., applying no other materials to remove the sacrificial material) or concurrent or sequentially with other materials to remove the sacrificial material. The sacrificial material (including the PVA) can still be water soluble after FDM processing (i.e., depositing and bonding with the part material).

After the water has been applied and removed, the part can be inspected, for example to check for specific marking materials (e.g., by application and detection of visual light, fluorescing energy (e.g., exposing to a UV “black light”), ultrasound energy, radiation energy (e.g., an x-ray), or combinations thereof) to confirm removal of all, or at least a desired portion of the sacrificial material from the part material.

The part or component can be made by alternately depositing segments of the part or component material and segments of the sacrificial material. Some component material segments can be deposited onto sacrificial material segments. The sacrificial material can be soluble in water and contain the additive material (e.g., adhesion enhancer), for example, improving adhesion between the sacrificial material segments and the component material segments.

The sacrificial material can be used to fabricate parts where the absence of support material would not allow for the part to be made, for example based on the part geometry.

The % compositions shown herein are by weight (i.e., “% w/w”) unless specified otherwise.

Any elements described herein as singular can be pluralized (i.e., anything described as “one” can be more than one). The terms “part” and “component” are used interchangeably herein. The terms (PS-b-PVA) and (PVA-b-PS) are used interchangeably herein. Any species element of a genus element can have the characteristics or elements of any other species element of that genus. The above-described materials, methods, and their elements for carrying out the disclosure, and variations of aspects of the disclosure can be combined and modified with each other in any combination.

I claim:

1. A method for three-dimensional printing comprising:
depositing a sacrificial material, wherein the sacrificial material comprises a block co-polymer; and
depositing a part material on the sacrificial material.

2. The method of claim 1, wherein the three-dimensional printing comprises FDM.

3. The method of claim 1, wherein the sacrificial material comprises PVA.

4. The method of claim 1, wherein the sacrificial material comprises an ABS-bonding molecule combined with PVA.

5. The method of claim 1, wherein the part material comprises ABS.

6. The method of claim 1, wherein the sacrificial material is water soluble.

7. The method of claim 1, further comprising removing the sacrificial material, wherein the removing comprises applying water to the sacrificial material.

8. The method of claim 1, further comprising at least one of a comb polymer, star polymer, dendritic polymer, co-polymer, ter-polymer or tetra-polymer.

9. A sacrificial material for three-dimensional printing against a part material comprising:
a base polymer; and
a block co-polymer.

10. The material of claim 9, wherein the block co-polymer is configured to assist with adhesion between the polymer and the part material.

11. The material of claim 9, wherein the polymer comprises more than 50% polyvinyl alcohol.

12. The material of claim 9, further comprising at least one of a comb polymer, star polymer, dendritic polymer, co-polymer, ter-polymer or tetra-polymer.

13. The material of claim 9, wherein the block co-polymer comprises a first block segment with a solubility parameter from about 75% to about 125% of the solubility parameter of the base polymer, and wherein the co-polymer further comprises at least one second block segment with a solubility parameter from about 75% to about 125% of the solubility parameter of the part material.

14. The material of claim 9, wherein the block co-polymer comprises a first block segment having wettability or solubility toward the base polymer, and wherein the co-polymer further comprises at least one second block segment having wettability and/or solubility toward the part material.

15. The material of claim 9, further comprising a second polymer of the group consisting of co-polymer, tri-polymer, and tetra-polymer; and wherein the further polymer comprises either a block or random polymer, and where a first monomer moiety of the second polymer is vinyl alcohol.

16. The material of claim 15, wherein a second monomer of the second polymer moiety is styrenic.

17. The material of claim 14, wherein the part material comprises ABS.

18. The material of claim 13, further comprising a diblock copolymer comprising PVA and styrenic blocks, and further comprising a part material comprising ABS.

19. The material of claim 15, wherein the third monomer moiety of the second polymer comprises isobutylene.

20. A method for making a part through additive manufacture comprising:
depositing a sacrificial material, wherein the sacrificial material comprises a PVA composition having an adhesion enhancer;
depositing a part material on the sacrificial material;
repeating the steps for the build-up of a part with the part material and PVA with adhesion enhancer; removing and post treating the part; dissolving the PVA with adhesion enhancer to produce a part from part material.
